(19) United States
(12) Patent Application Publication
(10) Pub. No.: US 2011/0150015 A1
(43) Pub. Date: Jun. 23, 2011

(54) Generation of frequency-pre-selectable radiation by using more than one cascaded frequency conversion processes of resonantly enhanced beams

(75) Inventor: Jianping Zhou, Palo Alto, CA (US)

(73) Assignee: Dr. Jianping Zhou, Palo Alto, CA (US)

(21) Appl. No.: 12/968,092

(22) Filed: Dec. 14, 2010

Related U.S. Application Data
(60) Provisional application No. 61/284,304, filed on Dec. 15, 2009.

(51) Int. Cl. H01S 3/10

(52) U.S. Cl. 372/20

(57) ABSTRACT

The invention describes methods and apparatus for the generation of laser radiation with pre-selectable frequency, which could be bigger or smaller than its fundamental beam frequency, through a combination of two or more intracavity frequency conversion processes of two or more resonantly enhanced beams. These techniques are particularly useful for generating continuous wave tunable frequency radiation in uv, visible and infrared wavelength ranges. These processes can be a combination of an intracavity fundamental beam pumped optical parametric oscillation (OPO) and an intracavity sum- or difference-frequency-mixing of the fundamental laser beam with an OPO generated beam and an intracavity frequency doubling the optical parametrical generated signal or idler beam to desirable frequencies for continuous wave. These plural intracavity nonlinear processes can be a combination of an intracavity or resonantly cavity-build-up fundamental beam pumped OPO and another frequency conversion within this OPO and the fundamental cavity. These intracavity enhanced frequency conversion processes allow for minimizing the parent frequency beams' losses and increasing the final conversion and, particularly, highly efficient conversion for continuous waves.

### CROSS REFERENCE TO RELATED APPLICATIONS

The present application claims priority to U.S. Provisional Patent Application Series No. 61/284,304, filed Dec. 15, 2009, the contents of which are incorporated by reference in its entirety herein.

### BACKGROUND OF THE INVENTION

In recent years, applications of specific frequency laser light have increased dramatically. For example, red, green, and blue laser lights are generated to display images with much wider color ranges, orange, yellow, and red laser lights are used in ophthalmic treatments, blue, green, yellow and orange lights are all used in biological and biomedical applications.

For some of these applications, the existing known gain media can supply needed color light at variety power levels, such as gas, solid-state, electrically-pumped semiconductor and optically-pumped semiconductor lasers for ultra violet, visible and infrared beams. Gas lasers can generate good ultraviolet (uv), visible and infrared (ir) color light. Electrically or optically pumped semiconductor lasers can generate ir and near ir fundamental laser light. However, gas lasers are usually big and work with very low energy efficiency. Semiconductor lasers are not available for direct light generation between green and red color with good beam quality. Optically-pumped and electrically-pumped semiconductor lasers are capable of producing blue-to-green light through intracavity or extracavity frequency doubling or tripling conversion.

There are many useful wavelengths are not easily available today, especially, with continuous wave (cw) operation, such as, red light with wavelength between 625 nm and 635 nm, 560 nm and 591 nm laser lights for laser image display or biomedical and biological instrumentations. Laser image display has a need of low-cost and reliable red laser light. A method of pulsed red laser light, generated by using repetitively pulsed sum-frequency-mixing of an intracavity 1064 nm beam pumped optical parametric oscillator (OPO)'s signal beam with its fundamental pump beam, was reported to produce 626-629 nm in U.S. Pat. No. 6,483,556 by Masayuki Karakawa, Robert J. Martinsen and Stephen R. McDowell. However, a typical Q-switched pulsed laser can only produce pulsed output and requires an extra Q-switch device and associated electronics. Therefore, the cost of such a system is very high. Praseodymium-doped YLF laser can generate specific color at 607 nm and 639 nm and other frequency laser light, but requires blue light pumping. Therefore the laser is very expensive. Laser light with 639 nm is also too deep in red color for display application. There is a need for generating wavelength or frequency-pre-selectable laser light for many of these applications. Previous inventions did not solve a problem of generating continuous wave (cw) visible radiation with simple laser architectures.

In response thereto, a number of harmonic conversion methods have been used to generate other laser frequencies which is not available through direct gain media amplified stimulated emission. One traditional way is to use intracavity frequency doubling or tripling or quadropling to generate two-times, or three-times, or four-times of its fundamental frequencies. These intracavity frequency multipling methods can generate efficient harmonic frequencies. However, these frequencies are discrete and not pre-selectable.

In response to thereto, a number of optical parametric amplification (OPA) methods were used to generate wavelength or frequency-pre-selectable laser output beams at infrared frequencies. Intracavity pumped optical parametric oscillator (OPO) was proposed By Yusong Yin in U.S. Pat. No. 6,108,356 for generating pre-selected it radiation. Most of these parametric oscillators require strong pumping laser pulse to overcome, typically, low parametric amplification gain, particularly, in cw case. Extracavity beam pumped OPO and therein intracavity difference-frequency-mixing schemes were reported by Karl Koch, Gerald T. Moore, and E. C. Cheungy in “Optical parametric oscillation with intracavity difference-frequency mixing,” J. Opt. Soc. Am. B Vol. 12, 2268-2273 (1995) and M. E. Dearborn, Karl Koch, Gerald T. Moore, and J. C. Diels in “Greater than 100% photon-conversion efficiency from an optical parametric oscillator with intracavity difference-frequency mixing,” Opt. Lett., Vol. 23, 759-761 (1998) and Da-Wun Chen and Kevin Masters in “Continuous-wave 4.3-μm intracavity difference frequency generation in an optical parametric oscillator,” Opt. Lett., Vol. 26, 25-27 (2001) for generating mid-infrared to tera-hertz frequency radiation. Both extracavity and intracavity beam pumped optical parametric oscillators were reported for generating it output. Sum-frequency-mixing of two cw single-mode population-inverted Nd:YAG laser beams in a doubly resonant congruent lithium niobate resonator was reported to generate two TEM₀₀ beams of single-frequency 589 nm radiation by Joseph D. Vance, Chiao-Yao She, and Hans Moosmuller in “Continuous-Wave, All-Solid-State, Single-Frequency 400-mW Source at 589 nm Based on Doubly Resonant Sum-Frequency Mixing in a Monolithic Lithium Niobate Resonator,” Appl. Opt., Vol. 37, 4891-4896 (1998). Extracavity beam pumped OPO with intracavity frequency-mixing of the generated signal or idler beam with its non-resonantly enhanced original pump beam can generate sum- or difference-frequency output, reported by S. T. Lin, Y. Y. Lin, R. Y. Tu, T. D. Wang and Y. C. Huang in “Fiber-laser-pumped CW OPO for Red, Green, Blue Laser Generation,” OSA/CLEO/IQEC, CWJ4 (2009). However, the mixing process conversion efficiency is usually very low due to only one of the beams is resonantly enhanced for continuous waves, particularly, for cases of using more than one frequency conversion processes.

In light of foregoing, there is an ongoing need for high efficiency frequency conversion methods that can generate highly efficient, frequency-pre-selectable, plural times nonlinear frequency converted radiation of continuous waves.

### SUMMARY OF THE INVENTION

Accordingly, various embodiments of the present invention are disclosed herein. An object of the present invention is to provide continuous wave laser systems, and their methods of use, that obtain output radiation through more than one nonlinear frequency conversion processes by using plural resonantly enhanced laser beams. For example, one of the resonantly enhanced beam is an intracavity pump beam of the first frequency conversion process, such as, OPO.

Yet an object of the present invention is to provide continuous wave (cw) and quasi-cw laser systems, and their methods of use, that have high efficiency of frequency conversion through the use of more than one resonantly enhanced beams in two or more nonlinear frequency conversion processes.

Yet an object of the present invention is to provide continuous wave and quasi-cw systems, and their methods of use, that allow the frequency converted laser frequency being tunable in certain frequency range.

Yet an object of the present invention is to provide continuous wave and quasi-cw laser systems, and their methods of use, that are cheap to be made and easy to be made.

Yet an object of the present invention is to provide continuous wave and quasi-cw laser systems, and their methods of use, that deliver stable converted output beam with wavelength in uv, visible and it ranges.

Yet an object of the present invention is to provide continuous wave and quasi-cw laser systems, and their methods of use, that deliver good spatial quality beam.

Yet an object of the present invention is to provide continuous wave and quasi-cw laser systems, and their methods of use, that only output the final desired frequency converted light beam, e.g., without outputting its parent beam(s).

These and other objects of the present invention are achieved in laser systems with more than one nonlinear frequency conversion processes. A pump source provides energy to induce population inversion in a laser gain medium. First and second mirrors define a fundamental beam resonant cavity. This fundamental cavity does not have to couple out significant fundamental radiation through partially reflective coated mirror, or similar mechanisms. This laser gain medium is positioned in a resonator and is optically or electrically or thermally coupled to the pump source for transferring the energy. At least one nonlinear frequency conversion medium is also placed in the fundamental resonator to convert the fundamental beam into another frequency-pre-selectable beam or beams. At least, another nonlinear frequency converting medium is also placed in the fundamental laser resonator to transfer two or more of the upper mentioned fundamental beam and the generated frequency-pre-selectable beam into another frequency-pre-selectable radiation.

In another embodiment of the present invention, methods are provided for converting the continuous wave fundamental laser beam into two lower frequency beams in an intracavity pumped optical parametric oscillator (OPO), in which one is called signal beam and the other is called idler beam and at least one of the frequencies is pre-selectable. This OPO cavity has its own resonant cavity to resonate with one of the signal or idler beams or both. This OPO resonant cavity shares its cavity boundary with the fundamental beam cavity partially or in the whole. The resonant signal or idler beam does not have to, but could, leak out through partially reflective cavity mirrors.

In another embodiment of the present invention, methods are provided for generating another frequency-pre-selectable beam by mixing one of the OPO generated signal or idler beam with its fundamental pump beam in both fundamental and OPO cavities. Another nonlinear conversion medium is placed in a common path of both the fundamental beam cavity and the OPO cavity to convert two or more resonantly enhanced beams into a frequency-pre-selectable radiation. Since both the fundamental and signal or idler beams are enhanced in their resonators, the conversion efficiency is high or optimized.

In another embodiment of the present invention, a method is provided for enhancing the fundamental beam further by using a Smith-Fox interferometer cavity with or without cavity feedback control loop and, therefore, the conversion is further optimized.

In another embodiment of the present invention, a method is provided for enhancing the fundamental beam further by using an unidirectional ring resonant cavity with or without feedback control loop and the conversion is further optimized.

In another embodiment of the present invention, a method is provided for controlling the output beam frequency, and therefore, wavelength, by implementing etalon devices or etalon effects into the gain medium, or an intracavity optics, or the frequency converting medium or a combination of them.

In another embodiment of the present invention, a method is provided for controlling the output beam frequency, and therefore, wavelength, by implementing birefringent filtering devices and effects into the gain medium, or as an intracavity optics, or the frequency converting media or a combination of them.

In another embodiment of the present invention, a method is provided for controlling the output beam frequency and conversion efficiency and beam quality, by implementing quarter-wave or half-wave retardation plates into the gain medium, or one or more of the intracavity optics, or the frequency converting media or a combination of them with one or more polarization devices resided in the cavity.

### BRIEF DESCRIPTION OF THE DRAWINGS

FIG. 1 is a schematic diagram illustrating one embodiment of a cw fundamental resonator overlaps with a resonant OPO cavity completely.

FIG. 2 is a schematic diagram illustrating one embodiment of a fundamental cw resonator overlaps with a resonant OPO cavity partially.

FIG. 3 is a schematic diagram illustrating one embodiment of using separate cavity end boundaries for the fundamental cw resonator and the OPO resonator.

FIG. 4 is a schematic diagram illustrating one embodiment of using a Smith-Fox interferometer to enhance the fundamental cw beam further for improving the frequency conversion efficiency.

FIG. 5 is a schematic diagram illustrating one embodiment of using a unidirectional resonant cavity to enhance the fundamental beam further for improving the frequency conversion efficiency.

FIG. 6 is a schematic diagram illustrating one embodiment of the invention with mode-locked mode operation.

FIG. 7 is a schematic diagram illustrating one embodiment of the invention with acousto-optic modulator modulated mode-locked cavity.

FIG. 8 is a schematic diagram illustrating one embodiment of controlling the fundamental or OPO frequency by implementing one or more etalon devices into its cavity, gain medium, or frequency conversion crystals or a combination of them.

FIG. 9 is a schematic diagram illustrating one embodiment of controlling the fundamental and/or OPO beam frequency by implementing one or more birefringent filter devices or quarter-wave or half-wave retardation plates into its cavity, gain medium, or frequency conversion crystals or a combination of them.

FIG. 10 shows cavity, gain, and filter loss curves in a frequency controlled cavity system.

FIG. 11 is a typical laser cavity spectral resonance response including wavelength filters.

### DETAILED DESCRIPTION OF THE PREFERRED EMBODIMENT

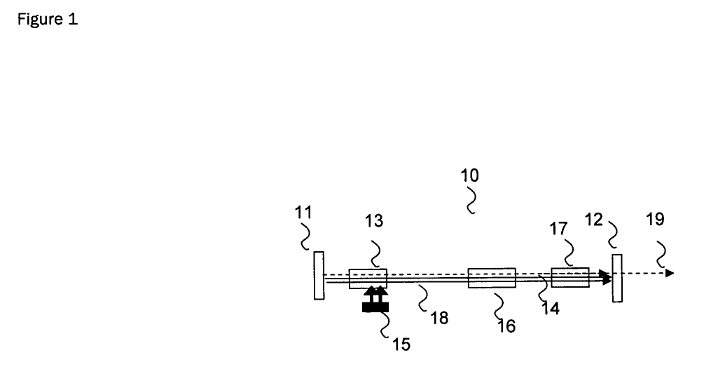

As illustrated in FIG. 1, in one of the embodiments of the present invention, a plural intracavity resonantly enhanced nonlinear frequency conversion laser system, generally denotes as 10, includes a fundamental frequency laser gain medium 13 surrounded by, at least, two cavity mirrors 11 and 12 to form a resonant cavity. Energy of the gain medium is supplied by an energy source 15. The gain medium 13 absorbs energy from an energy source, such as, diode laser radiation, electric energy, or thermal or mechanical kinetic energy. In various embodiments, the fundamental frequency gain medium can be any kind of solid state, liquid, gas, or plasma, such as, argon-ion gas, helium-neon gas, Nd:YAG/YLF/YAP/YVO₄/LuV O₄/GdVO₄, Ti:S, Li:SAF, Yb-doped YAG/YLF/YAP/YVO₄/GdVO₄/KGW/KYW, electrically-pumped or optically pumped semiconductor, quantum-well materials, etc. The fundamental beam 14 is resonant enhanced oscillation radiation by the cavity mirror 11 and 12 around gain 13 once they are aligned.

Mirror 11 and 12 with proper coatings can also be cavity end mirrors of an optical parametric oscillator (OPO) embedded in the fundamental laser cavity as shown in FIG. 1. The OPO cavity also includes an OPO gain medium 16 to convert the fundamental frequency beam into two lower energy photon beams, generally denoted as 18. Another frequency conversion medium 17 is also located in both cavities to mix the pump beam with the generated signal or idler to generate the final pre-selected frequency beam 19. This final beam propagates out of the cavities through mirror 12 efficiently through a carefully designed transmission coating on it. Since both beam 14 and 18 are resonantly enhanced, the mixing of them generates efficiently converted beam of the final pre-selected frequency radiation. In case of mixing the OPO generated signal beam with the idler beam, the output efficiency is also improved due to the OPO is pumped with an intracavity resonantly enhanced fundamental beam.

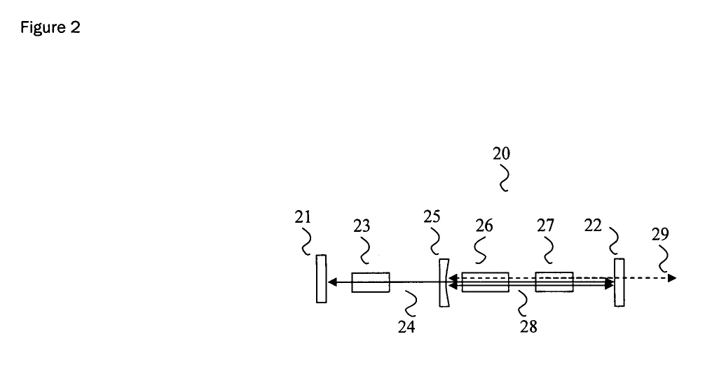

FIG. 2 illustrates another embodiment of the invention. In this case, one of the OPO end mirror 25 is used to form an OPO cavity with mirror 22 so that one or both of the OPO generated resonant beams do not go through the fundamental cavity gain medium for minimizing the cavity loss. Therefore, the generated one or both of the OPO signal and idler beams are further enhanced. Either one of the nonlinear frequency converting media 26 and 27 can be used for OPO generation and frequency mixing. Their locations are permutable for best conversion. These two frequency conversion media can be manufactured into one single piece, such as, periodically poled lithium niobate (PPLN), PPKTP, PPSLT chip, which contains one or more domain-reversed periods engineered for desired frequencies.

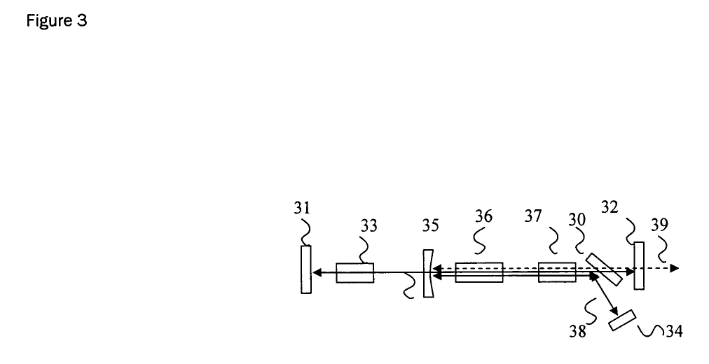

FIG. 3 illustrates another embodiment of the invention. In this case, both the OPO end mirrors are not shared with the fundamental cavity for optimal OPO conversion. Mirror 30 is a dichroic mirror for best reflecting the OPO beam or beams and transmitting the fundamental beam and relaxing the coating requirements on mirror 32.

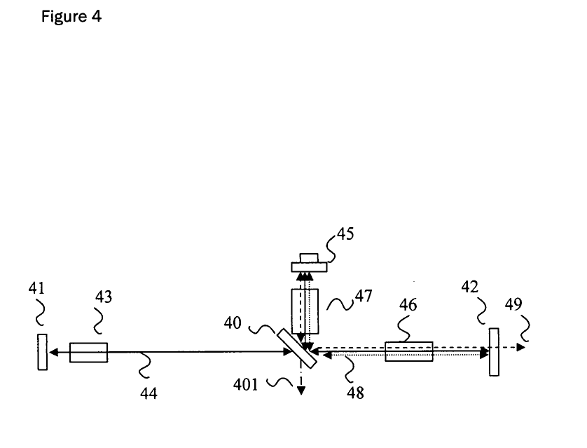

In order to further enhance the fundamental beam intensity, FIG. 4 illustrates another embodiment of the invention, in which a Fox-Smith interferometer cavity, formed with 45, 40, 42, 41 and coupled with the fundamental cavity 41 and 42, enhances further the fundamental beam inside the path of 42 to 40 to 45. By coating these mirrors with high reflection at one or both of the OPO signal and idler frequencies and placing an OPO conversion medium at 47 or 46, this part of the Fox-Smith interferometer forms an OPO cavity. Because of the enhancement of the fundamental frequency beam, the OPO beams are generated with very high efficiency, particularly, for continuous wave case. The other frequency converting medium, 46 or 47, mixes the generated OPO beam with the fundamental beam through sun-frequency-mixing (SFM) for visible radiation or difference-frequency-mixing the two OPO signal and idler beams to generate efficient it or THz radiation. Mirror 45 is mounted on an adjustable mount, such as PZT or equivalent, to keep the interferometer resonating with the fundamental beam for maximum intensity enhancement by detecting a signal 401 and controlling the cavity.

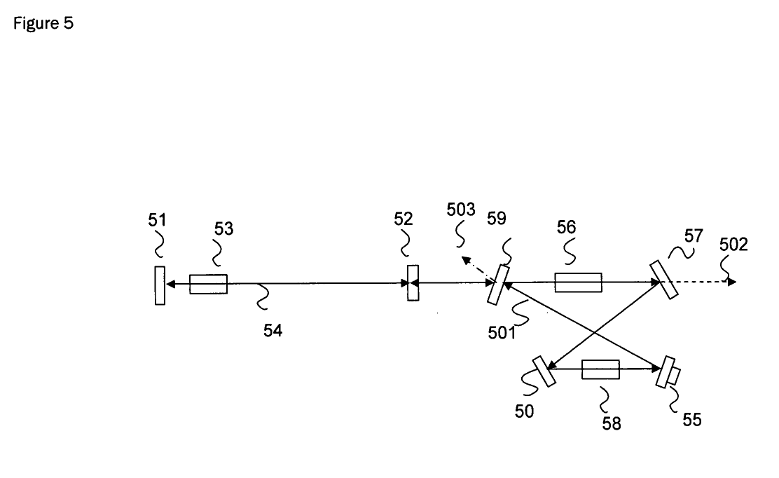

In order to further enhance the fundamental beam intensity, FIG. 5 illustrates yet another embodiment of the invention, in which a build-up unidirectional ring cavity, formed with 59, 57, 50, 55 and coupled with the fundamental cavity 51 and 52, enhances further the fundamental beam inside the path of 59 to 57 to 50 to 55 to 59 and the cavity length stabilized or synchronized with the fundamental cavity through feedback loop using, such as, a PZT driven mirror 55 by detecting signal 503. With high reflection coatings for one or both of signal and idler frequency beams on mirror 59, 57, 50, and 55, respectively, and with placing an OPO gain medium 58 in, this ring cavity also forms an OPO resonator. Because of the enhancement of the fundamental frequency beam and its unidirectional pumping, the OPO beams are generated resonantly and unidirectionally with high efficiency as well. By placing another frequency converting medium 56 in, the final output beam 502 is efficiently generated by mixing the enhanced fundamental beam with one of the OPO signal and idler beams or by difference-frequency-mixing the signal and idler beam themselves with singly or doubly resonated OPO cavity.

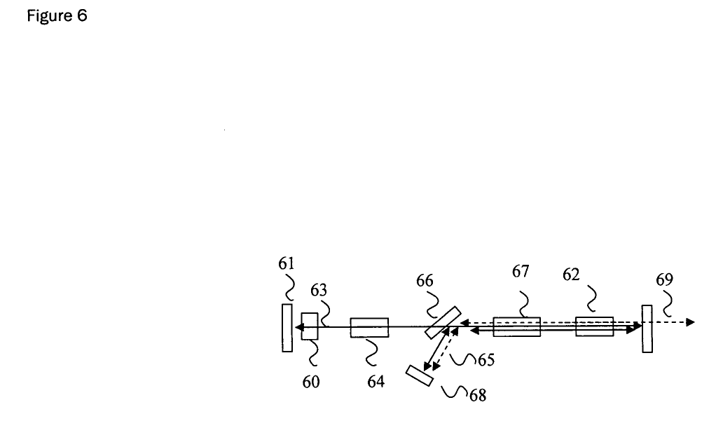

The upper mentioned embodiments also work with a mode-locked laser cavity denoted as in FIG. 6. In this embodiment of the present invention, the fundamental laser cavity includes a gain or loss modulator 60. This loss modulator could be an acousto-optical modulator (AOM) mode-locker, an electro-optical modulator (EOM), a passive Q-switch (Q-S) modulation medium, an active AO modulator, a mechanical shutter, etc, which modulates the cavity loss through active or passive action.

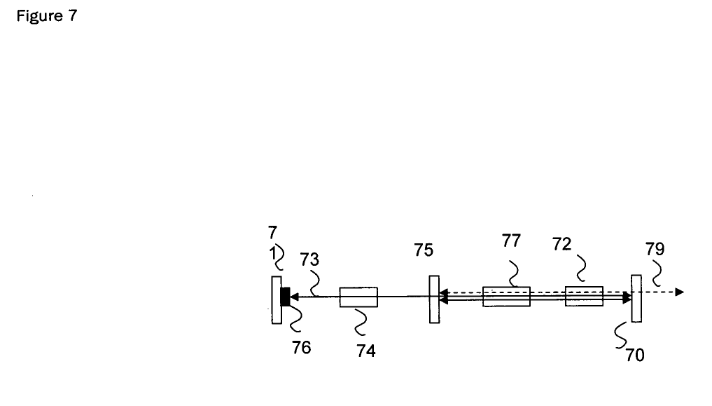

The upper mentioned embodiments also work with a mode-locked or Q-switch mode-locked laser cavity denoted as in FIG. 7. In this embodiment of the present invention, the fundamental laser cavity includes a gain or loss modulation device 76. This loss modulator 76 is a semiconductor saturable absorber mirror (SESAM), a semiconductor bulk medium, a solid state medium, such as, Cr:YAG, a Kerr-lens-effect medium, an acousto-optic modulator driven actively or passively, a quantum-dot device, or nano-materials, such as carbon nano-tubes, etc., which modulates the cavity loss through active or passive action.

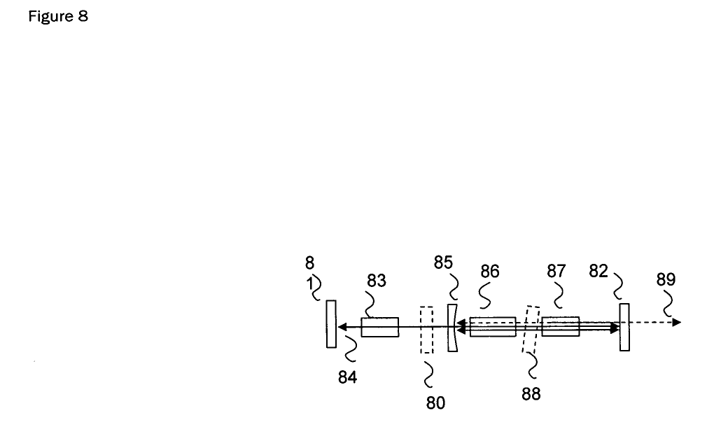

Another embodiment of the present invention, a method is provided, as shown in FIG. 8, for stabilizing the fundamental laser cavity 81-to-82 or both of the fundamental laser cavity and the resonant conversion cavity 85-to-82 by inserting frequency pre-selected etalon device 80 or 88 into one or both these cavities.

Another embodiment of the present invention, a method is provided, as shown in FIG. 8, for stabilizing the fundamental laser cavity 81-to-82 or both the fundamental laser cavity and the resonant OPO conversion cavity 85-to-82 by inserting quarter-wave or half-wave retardation plates for one or more beams at location of 80 or 88 into one or both of these cavities for splitting each of the fundamental and OPO beams into two orthogonally polarized beams for OPO and frequency-mixing, respectively.

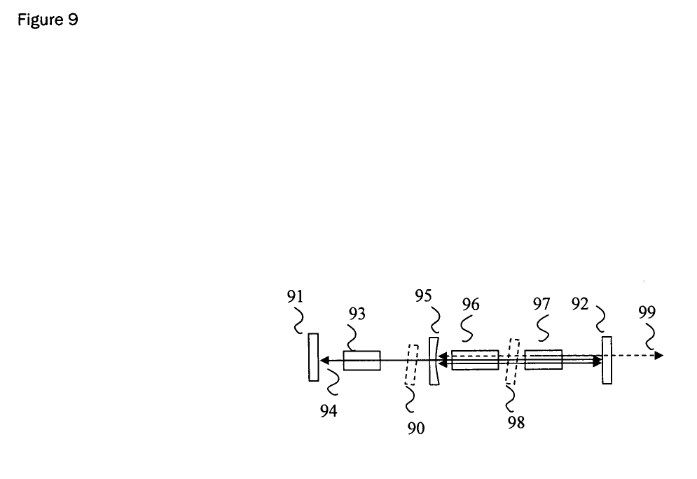

Another embodiment of the present invention, a method is provided, as shown in FIG. 9, for stabilizing the fundamental laser cavity 91-to-92 or both the fundamental laser cavity and the resonant conversion cavity, such as OPO, 95-to-92 by making one or more of the fundamental laser gain medium and frequency-conversion media have frequency discrimination effect through birefringent filtering effect.

All of etalon and birefringent filters and wave retardation plates can be also manufactured into one or more of the end mirror optics 91, 92, and 95 in FIG. 9 by having one surface coated with partial reflectivity and the other surface coated with high reflectivity or having them manufactured with birefringent materials at non-90-degree incidence to have polarization discrimination effect.

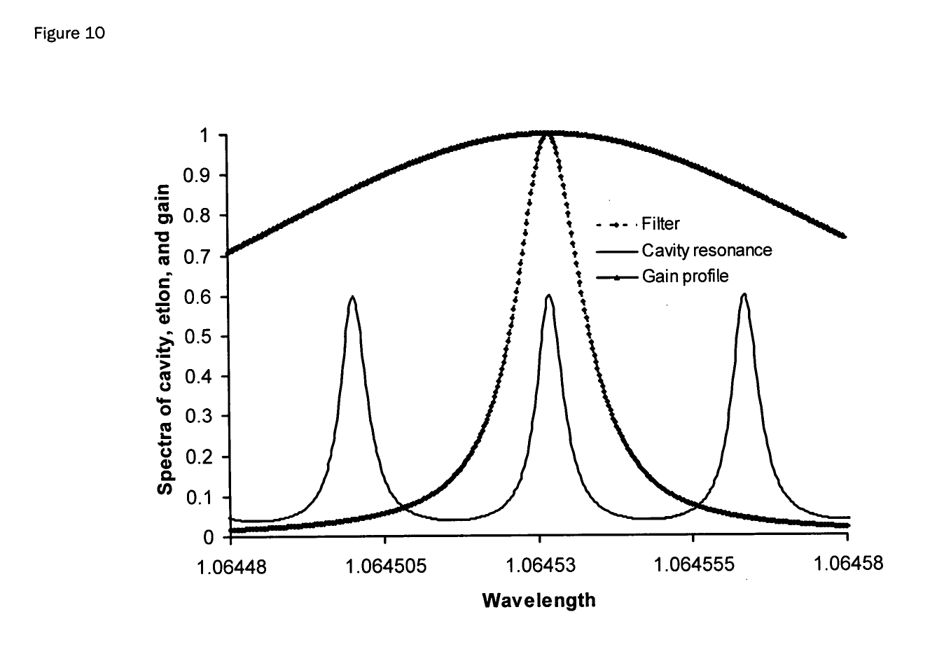

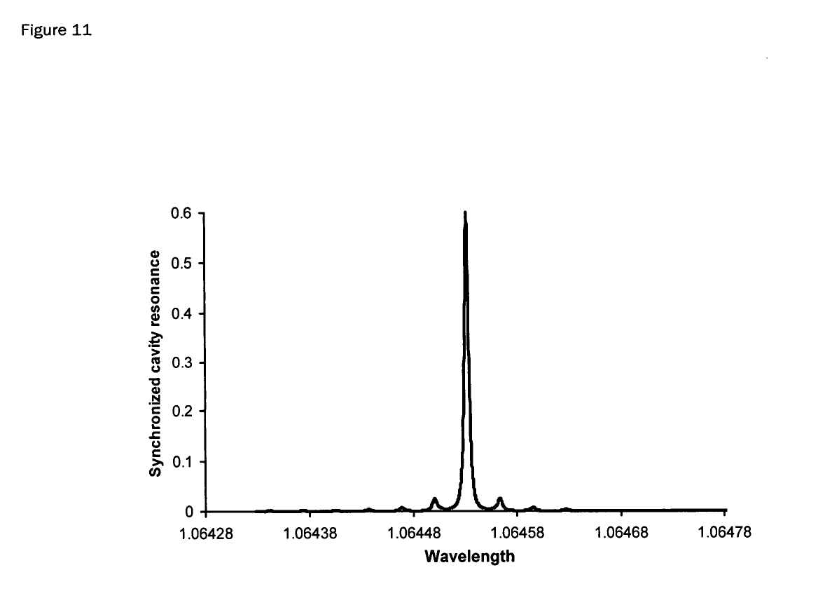

Another embodiment of the present invention is to choose etalon or birefringent filter with peak frequency to match the laser cavity mode and the maximum gain peak frequency for best efficiency and best stability as denoted in FIG. 10. FIG. 11 shows a typical final cavity spectral response to different wavelength of light inside such cavities.

The forgoing description of a preferred embodiment of the present invention has been presented for the purpose of illumination and description. It is not intended to be exhaustive or to limit the invention to the precise forms disclosed. Obviously, many modifications and variations will be apparent to practitioners skilled

### REFERENCES CITED

U.S. Patent Documents

| | | | |
|---|---|---|---|
| 6,483,556 A | November 2002 | Karakawa | 348/750 |
| 6,108,356 A | August 2000 | Yin | 372/22 |
| 7,489,437 A | February 2009 | Bauco | 359/326 |
| 6,774,881 A | October 2001 | Karakawa | 345/84 |
| 5,333,142 A | December 1993 | Scheps | 372/22 |
| 6,233,025 A | May 2001 | Wallenstein | 348/750 |
| 6,219,363 A | April 2001 | Fix | 372/22 |
| 6,101,023 A | August 2000 | Meyer | 359/330 |
| 5,159,487 A | October 1992 | Geiger | 359/330 |

A. Fix, G. Ehret, “Intracavity frequency mixing in pulsed optical parametric oscillators for the efficient generation of continuously tunable ultraviolet radiation,” Appl. Phys. B 67, 331-338 (1998)
P. W. Binun, T. L. Boyd, M. A. Pessot, D. H. Tanimoto, D. E. Hargis, “Pr:YLF, intracavity-pumped, room-temperature upconversion laser,” Opt. Lett., Vol. 21, 1915-1957 (1996).
S. T. Lin, Y. Y. Lin, R. Y. Tu, T. D. Wang and Y. C. Huang, “Fiber-laser-pumped CW OPO for Red, Green, Blue Laser Generation,” OSA/CLEO/IQEC, CWJ4 (2009)
Y. C. Huang, “Fiber-laser-pumped Cw Opo For Red, Green, Blue Laser Generation,” in Nonlinear Photonics, OSA Technical Digest (CD) (Optical Society of America, 2010), paper NME6
M. E. Dearborn, Karl Koch, Gerald T. Moore, and J. C. Diels, “Greater than 100% photon-conversion efficiency from an optical parametric oscillator with intracavity difference-frequency mixing,” Opt. Lett., 23, 759-761 (1998)
Da-Wun Chen and Kevin Masters, “Continuous-wave 4.3-μm intracavity difference frequency generation in an optical parametric oscillator,” Opt. Lett., 26, 25-27 (2001)
Joseph D. Vance, Chiao-Yao She, and Hans Moosmüller, “Continuous-Wave, All-Solid-State, Single-Frequency 400-mW Source at 589 nm Based on Doubly Resonant Sum-Frequency Mixing in a Monolithic Lithium Niobate Resonator,” Appl. Opt. 37, 4891-4896 (1998)
Karl Koch, Gerald T. Moore, and E. C. Cheungy, “Optical parametric oscillation with intracavity difference-frequency mixing,” J. Opt. Soc. Am. B 12, 2268-2273 (1995)
G. T. Moore, K. Koch, “Optical parameter oscillation with detuned intracavity sum-frequency generation,” IEEE J. of Quantum Electronics, Vol 29, 2334-2341 (1993).
G. T. Moore, K. Koch, M. E. Dearborn, “Gain enhancement of multistage parametric intracavity frequency conversion,” IEEE J. of Quantum Electronics, Vol. 33, 1734-1742 (1997).

What is claimed is:

1. A frequency-pre-selectable laser system, compromising:
A pump energy source that produces pump energy;
First and second mirrors that define a resonant cavity;
A gain medium positioned in the resonant cavity and optically or electrically or thermally coupled to the pump energy;
Another two mirrors or the same set of upper mentioned mirrors or a mixed set of upper mentioned and new mirrors that define another optical resonant cavity for pre-selectable frequency conversion;
A frequency converting medium positioned in the second cavity and optically coupled to the first cavity resonantly enhanced beam;
A second frequency converting medium positioned in a common part of the two cavities and optically coupled to both cavities' resonant beams; or in the second cavity;
A second frequency converting medium positioned in the second cavity only;
This second frequency converting medium positioned in the second cavity for converting the two second-cavity generated resonant or non-resonant beams;
A third frequency converting medium positioned in part of the first or second cavity for converting more of these generated beams with higher order frequency conversion;
An output optic that couples the final generated frequency beam out from the laser system.

2. The system of claim 1, wherein the first cavity is a population inverted laser cavity.

3. The system of claim 1, wherein the population inverted gain medium is selected from argon-ion gas, CO₂ gas, helium-neon gas, liquids, or solids, such as, but not limited to, GaAs, AlGaAs, InGaAs, InPh, InPhGaAs, semiconductor material, Ti:S, Li:SAF, Pr:YLF Nd:YAG/YLF/YAP/YVO₄/LuV O₄/GdVO₄/KGW/KYW, Cr:YLF, Yb:YAG/YLF/YAP/YVO4/GdVO₄/KGW/KYW, etc.

4. The system of claim 1, wherein the gain energy source is a pump energy channel delivered through radio frequency electro-magnetic waves, through electricity, through light, through atomic or molecular mechanical collisions kinetic energy transformation.

5. The system of claim 1, wherein the second cavity is an optical parametric oscillator cavity with singly or doubly resonated signal and idler beams.

6. The system of claim 1, wherein the second cavity is a resonant enhanced build-up cavity.

7. The system of claim 1, wherein the OPO gain medium and the final frequency converting medium are selected from BBO, BiBO, LBO, CLBO, KBBF, LiNbO₃, KTP, KTA, KDP, KDA, PPKTP, PPLN, PPSLT, Quartz, AgGaS2, AgGaSe, GaAs, ZnSe, and any other nonlinear optical materials.

8. The system of claim 1, wherein the OPO converting crystal and the final frequency converting crystal are combined to a single piece with multi segments for both OPO frequency conversion and frequency-mixing and made of, such as, PPLN, PPSLT, PPKTP, bonded LBO, bonded BiBO, bonded BBO, GaAs, AgGaSe, AgGaS₂, etc.

9. The system of claim 1, wherein the OPO converting crystal alone is a single piece with multi segments of materials which are made of PPLN, PPSLT, PPKTP, bonded LBO, bonded BiBO, bonded BBO, GaAs, AgGaSe, AgGaS₂, etc, for wide frequency tuning capability.

10. The system of claim 1, wherein the OPO converting crystal is made in curved shapes of PPLN, PPSLT, PPKTP, LBO, BBO, BiBO, bonded LBO, bonded BBO, CLBO, etc, for wide frequency tuning capability and minimizing cavity or pointing instability.

11. The system of claim 1, wherein the first fundamental frequency beam is a continuous wave, or a pulsed wave, such as a mode-locked wave, or a single longitudinal frequency beam.

12. The system of claim 1, wherein the second frequency converting medium is a second-order or third-order nonlinear conversion crystal to mix two or three waves. Further higher-order nonlinear conversion process can be used to further mix more than three beams.

13. A method for producing frequency-pre-selectable output laser beam from a laser system, comprising:
Producing a pump energy source beam;
producing a resonated fundamental frequency beam in its cavity;
producing a frequency-pre-selectable resonant OPO beam;
producing two frequency-pre-selectable resonant OPO beams, e.g., signal and idler resonant beams.
producing a sun-frequency-mixed (SFM) output beam by mixing the fundamental cavity resonant beam with one of the resonant OPO beams;
producing a sun-frequency-mixed (SFM) output beam by mixing the fundamental cavity resonant beam with one of the non-resonant OPO beams;
producing a difference-frequency-mixed (DFM) output beam by mixing one of the OPO generated beam with the other OPO generated beam;
producing a mixed output beam by further mixing the upper mentioned mixed beam with the fundamental resonant beam.
producing a mixed output beam by further mixing the upper mentioned mixed beam with one of the intracavity OPO beams.

14. The system of claim 13, wherein the OPO cavity is pumped by the resonant fundamental frequency beam and generates two additional OPO beams, e.g., signal and idler beams.

15. The system of claim 13, wherein the OPO signal and idler beam are both or only one of them is resonated with the OPO cavity.

16. The system of claim 13, wherein the final frequency mixing crystal is detuned for the best mixed frequency beam stability and spatial beam quality.

17. The system of claim 13, wherein the OPO phase matching crystal is detuned for the best stability and beam spatial profile of the final frequency converted beam.

18. The system of claim 13, wherein one or more of the fundamental cavity mirrors and OPO resonant cavity mirrors are coated with lower than 100% reflectivity to stabilize the fundamental beam, OPO signal or idler beam and the frequency-mixed beam power and beam quality stability.

19. A method of producing stable and controlled pre-selectable frequency output beam from a laser system comprising:
An etalon in the fundamental laser cavity;
An etalon in the OPO cavity;
Etalons in both the fundamental laser and the OPO cavities
A birefringent filter in the fundamental laser cavity
A birefringent filter in the OPO cavity
Birefringent filters in both the fundamental laser and the OPO cavities
One etalon filter in both cavities as a frequency selection and control device.
One Birefringent filter in both cavities as a frequency selection and control device;
A set of etalon and birefringent filters used in any part of the laser system to control the final output beam frequency;
One or more wave retardation plates placed inside the fundamental cavity split the pump beam into two orthogonal polarized components to generate stable and good beam profile beams.
A set of filters used to filter out undesirable waves and send out desirable beams.

20. The system of claim 19, wherein one or more etalons are used to control the desired fundamental resonant radiation frequency and power stability.

21. The system of claim 19, wherein one or more birefringent filters are used to control the desired fundamental resonant radiation frequency and power stability.

22. The system of claim 19, wherein one or more etalon and birefringent filters are used to control the desired OPO generated radiation frequency and power stability.

23. The system of claim 19, wherein a combination of etalons and birefringent filters and wave retardation plates is used to control the final pre-selected frequency output radiation's stability and beam quality.

24. The system of claim 19, wherein one or more than one of wavelength filtering devices are used to only send out the desirable frequency beam.

25. The system of claim 19, wherein one or more of wave retardation plates are used to control frequency conversion efficiency and power stability.

26. The system of claim 19, wherein these wavelength controlling devices
are one or more than one of the birefringent and waveplates, etalons, polarizers, polarization beam splitters, interference filters, absorption and thin-film coated optics.
